(19) United States
(12) Patent Application Publication
(10) Pub. No.: US 2006/0217840 A1
(43) Pub. Date: Sep. 28, 2006

(54) Automatic cleaning system

(75) Inventor: Naoya Uehigashi, Osaka (JP)

Correspondence Address: Yokoi & Co., U.S.A., Inc., 13700 Marina Pointe Drive #723, Marina Del Rey, CA, 90292, US

(73) Assignee: Funai Electric Co., Ltd., Osaka (JP)

(21) Appl. No.: 11/386,391

(22) Filed: Mar. 22, 2006

(30) Foreign Application Priority Data
Mar. 24, 2005 (JP) JP2005-086314

(51) Int. Cl. G06F 19/00

(52) U.S. Cl. 700/245; 15/319; 701/23

(57) ABSTRACT

The automatic cleaning system according to the present invention comprises a radio wave generating device 70, a radio wave receiver antenna 61 for receiving a radio wave transmitted from the radio wave generating device 70, and a radio wave-strength measuring circuit 62 for measuring strength of the radio wave received by the radio wave receiver antenna 61. When radio wave-strength measured by the radio wave-strength measuring circuit 62 exceeds a predetermined threshold level, the number of revolutions of drive wheel motors 42R, 42L, a main brush motor 52, a side brush motor 58 and a suction motor 55 which are provided at a body BD of the self-propelled cleaner 10 are reduced, and loudness of a speaker 29b is reduced.

### BACKGROUND OF THE INVENTION

1. Field of the Invention

The present invention relates to an automatic cleaning system which comprises a self-propelled cleaner provided with a cleaner mechanism and a drive mechanism, and a radio wave generating device that can generate a radio wave of a predetermined wavelength.

2. Description of the Prior Art

Hitherto, there is known an electric cleaner which is constructed in such a manner to control an output of an electrically powered blower according to a level of noise produced around a body of the electric cleaner (for example, Japanese Patent Application Laid-Open No. Hei. 7-323 and Japanese Patent Application Laid-Open Nos. 2000-51127 and 2002-268746). According to electric cleaner of this type, when a person receives an interphone call or watches television, it is possible to reduce noise produced by the electric cleaner and prevent the person from failing to hearing voice.

Meanwhile, there is recently proposed a self-propelled cleaner that is provided with a cleaner mechanism for carrying out cleaning operation and a drive mechanism for realizing steering and driving of the self-propelled cleaner, and constructed so as to clean a floor surface of a room while being self-traveled along a predetermined route. In a case where the above-mentioned noise-reduction function is applied to this self-propelled cleaner, when no voice is given around the self-propelled cleaner, for example, while the person is sleeping etc., the above-mentioned noise suppressing function is not fulfilled, so that there is a problem that noise produced by the self-propelled cleaner becomes a disturbance of the sleeping etc.

### SUMMARY OF THE INVENTION

The present invention has been made with a view to overcoming the foregoing problem of the prior art cleaner.

It is therefore an object of the present invention to provide an automatic cleaning system that does not allow noise generated by a cleaner while a person is sleeping etc., to prevent the person's sleeping etc.

In order to attain the above-mentioned object, in accordance with one aspect of the present invention, there is provided an automatic cleaning system that comprises a self-propelled cleaner and a radio wave generating device for generating a radio wave of a predetermined wavelength, the self-propelled cleaner comprising a body, a cleaner mechanism provided at the body, a drive mechanism for realizing steering and driving of the body, a radio wave receiver circuit for receiving the radio wave generated from the radio wave generating device, a radio wave-strength measuring circuit for measuring strength of the radio wave received by the radio wave receiver circuit, and a noise suppressing control processor for reducing noise generated from the body in use of the self-propelled cleaner, when the radio wave-strength measured by the radio wave-strength measuring circuit exceeds a predetermined threshold level.

As discussed above, the automatic cleaning system according to the present invention comprises the self-propelled cleaner and the radio wave generating device. The self-propelled cleaner comprises the body provided with the cleaner mechanism, and the drive mechanism for realizing steering and driving of the body. Moreover, the radio wave generating device is adapted to be able to generate a radio wave of a predetermined wavelength.

Furthermore, the self-propelled cleaner is provided with the radio wave receiver circuit for receiving the radio wave generated from the radio wave generating device. As the radio wave receiver circuit, there may be employed, for example, an antenna etc. that can receive the radio wave generated from the radio wave generating device.

The self-propelled cleaner further includes the radio wave-strength measuring circuit for measuring the strength of the radio wave received by the radio wave receiver circuit, and the noise suppressing control processor for reducing the noise produced from the body in use of the self-propelled cleaner, when radio wave-strength measured by the radio wave-strength measuring circuit exceeds a predetermined threshold level. That is, when the self-propelled cleaner approaches a location spaced apart by a predetermined distance from a location at which the radio wave generating device is placed, the noise produced from the body is reduced. Thus, in a case where, for example, the user is sleeping in a condition where the radio wave generating device is located in the vicinity of the user, when the self-propelled cleaner approaches the location spaced apart by the predetermined distance from the radio wave generating device, the noise produced from the body are reduced. Therefore, the operation of the self-propelled cleaner will not prevent the user from sleeping. Incidentally; while a process for reducing the noise produced from the self-propelled cleaner body is not limited, it is favorable that an output of a drive system including motors etc. in the body is reduced.

In a preferred embodiment of the present invention, the drive mechanism includes drive motors for causing the body of the self-propelled cleaner to be travel-driven and the noise suppressing control processor is designed so as to cause the number of revolutions of the drive motors to be reduced.

In the embodiment constructed as described above, the number of the revolutions of the drive motors is reduced, whereby noise produced from the body can be reduced.

In another preferred embodiment of the present invention, the cleaner mechanism includes a main brush and a main brush motor for causing the main brush to be rotationally driven, and the noise suppressing control processor is designed so as to cause the number of revolutions of the main brush motor to be reduced.

In the embodiment constructed as described above, the number of the revolutions of the main brush motor is reduced, whereby noise produced from the body can be reduced.

In still another preferred embodiment of the present invention, the cleaner mechanism includes side brushes and a side brush motor for causing the side brushes to be rotationally driven, and the noise suppressing control processor is designed so as to cause the number of revolutions of the side brush motor to be reduced.

In the embodiment constructed as described above, the number of the revolutions of the side brush motor is reduced, whereby noise produced from the body can be reduced.

In yet another preferred embodiment of the present invention, the noise suppressing control processor is designed so as to control the body in such a manner to prevent the body from entering an area in which the radio wave-strength measured by the radio wave-strength measuring circuit exceeds the predetermined threshold level.

In the embodiment constructed as described above, the body of the self-propelled cleaner can be prevented from entering an area spaced apart by a predetermined distance from a location at which the radio wave generating device is placed, so that noise produced from the body of the self-propelled cleaner in use do not become a disturbance to the user.

In still another preferred embodiment of the present invention, the radio wave generating device is designed so as to be able to change strength of the radio wave to be generated, according to a predetermined operation.

In the embodiment constructed as described above, by changing the strength of the radio wave generated by the radio wave generating device, a distance between the radio wave generating device and the self-propelled cleaner at the time when radio wave-strength measured by the radio wave-strength measuring circuit of the self-propelled cleaner becomes the predetermined threshold level can be changed.

In still another embodiment of the present invention, the self-propelled cleaner is designed so as to be able to change the predetermined threshold level according to a predetermined operation.

In the embodiment constructed as described above, by changing the predetermined threshold level, a distance between the radio wave generating device and the self-propelled cleaner at the time when noise produced by the body of the self-propeller in use are reduced by the noise suppressing control processor can be changed.

Incidentally, while the present invention is applied to the automatic cleaning system that comprises the self-propelled cleaner and the radio wave generating device, the present invention is also applied to the self-propelled cleaner employed in the automatic cleaning system.

According to a further aspect of the present invention, there is provided a self-propelled cleaner that comprises a body, a cleaner mechanism provided at the body, a drive mechanism for realizing steering and driving of the body, a radio wave receiver circuit for receiving a radio wave generated from a radio wave generating device for generating a radio wave of a predetermined wavelength, a radio wave-strength measuring circuit for measuring strength of the radio wave received by the radio wave receiver circuit, and a noise suppressing control processor for reducing noise generated from the body in use of the self-propelled cleaner, when the radio wave-strength measured by the radio wave-strength measuring circuit exceeds a predetermined threshold level.

### BRIEF DESCRIPTION OF THE DRAWINGS

The above and other objects and many of the attendant advantages of the present invention will be readily appreciated as the same becomes better understood by reference to the following detailed description when considered in connection with the accompanying drawings, in which like reference numerals denote the same parts throughout the Figures and wherein:

FIG. 1 is a schematic perspective view illustrating an appearance of a self-propelled cleaner according to the present invention;

FIG. 2 is a schematic bottom plan view of the self-propelled cleaner of FIG. 1;

FIG. 3 is a schematic block diagram illustrating a structure of an automatic cleaning system comprised of the self-propelled cleaner shown in FIGS. 1 and 2, and a radio wave generating device;

FIG. 4 is a schematic view illustrating areas in which the body is to be subjected to a noise suppressing process;

FIG. 5 is a schematic flow chart exhibiting an automatic cleaning process;

FIG. 6 is a schematic view illustrating one example of a travel route along which the self-propelled cleaner is traveled at the time when the automatic cleaning process is carried out;

FIG. 7 is a schematic flow chart exhibiting the noise suppressing process;

FIG. 8 is a schematic block diagram illustrating a structure of an alternate of the self-propelled cleaner; and

FIG. 9 is a schematic view illustrating one example of a travel route of the alternate of the self-propelled cleaner.

### DESCRIPTION OF THE PREFERRED EMBODIMENTS

Embodiments of the present invention will be discussed hereinafter in the following order.

(1) Appearance of a self-propelled cleaner;

(2) Internal structure of the self-propelled cleaner;

(3) Operation of the self-propelled cleaner;

(4) Various alternates; and

(5) Summary.

(1) Appearance of a Self-Propelled Cleaner:

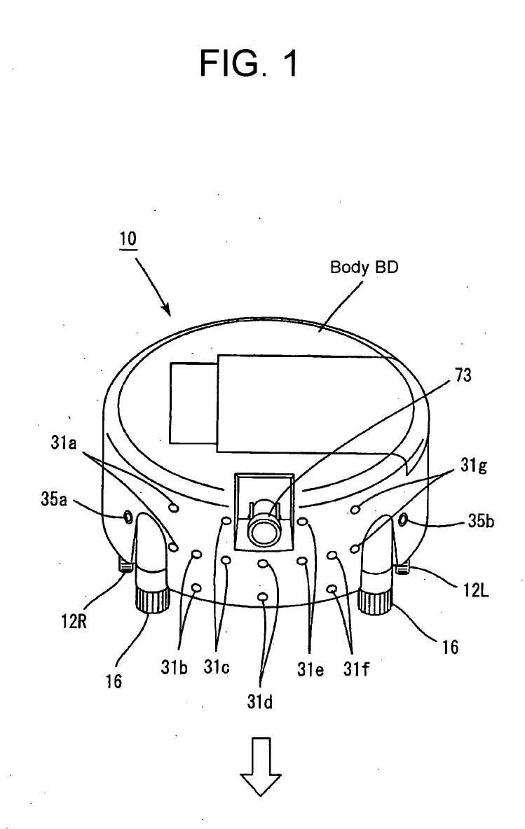

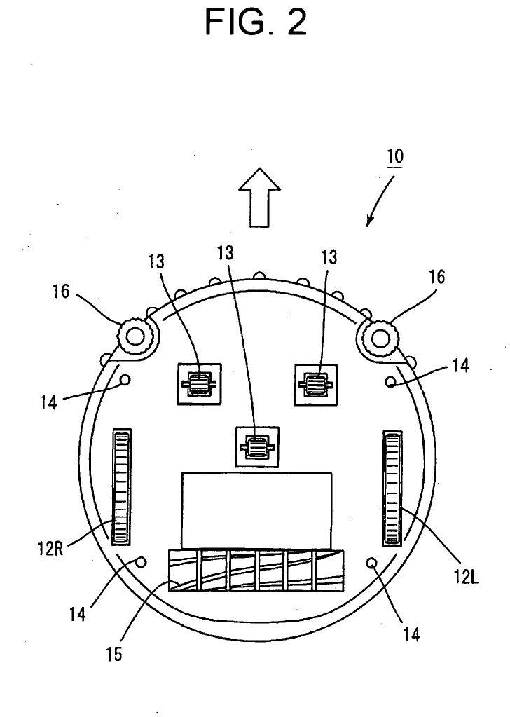

FIG. 1 is a schematic perspective view illustrating an appearance of a self-propelled cleaner being one of mechanisms constituting an automatic cleaning system according to the present invention. FIG. 2 is a schematic bottom plan view of the self-propelled cleaner shown in FIG. 1. Incidentally, a direction indicated by an arrow in FIG. 1 is a travel direction in which the self-propelled cleaner is advanced. As shown in FIG. 1, the self-propelled cleaner 10 according to the present invention includes a substantially cylindrical shaped body BD. Two drive wheels 12R, 12L (see FIG. 2) are provided at a bottom of the body BD. The drive wheels 12R, 12L are driven independently from each other, whereby the self-propelled cleaner 10 is adapted to be able to be advanced straightly, moved backward, and turned. Also, an infrared CCD sensor 73 acting as an image picking-up sensor is provided at a central portion of a front side of the body BD.

Seven ultrasonic sensors 31 (31a-31g) that serve as forward obstacle sensors for sensing an obstacle present ahead of the self-propelled cleaner 10 are provided at portions of the body BD that are below the infrared CCD sensor 73. Each of the ultrasonic sensors 31 comprises an ultrasonic wave dispatching section for generating an ultrasonic wave, and an ultrasonic wave receiving section for receiving the ultrasonic wave that is dispatched from the ultrasonic wave generating section, reflected by a forward wall of a room, and then returned toward the ultrasonic wave receiving section. The ultrasonic sensors 31 are adapted to be able to calculate a distance between the self-propelled cleaner and the forward wall on the basis of time required between the time when ultrasonic waves are dispatched from the ultrasonic dispatching sections and the time the ultrasonic waves are received by the ultrasonic wave receiving sections. Of these seven ultrasonic sensors 31, the ultrasonic sensors 31d are provided at the center portion of the front side of the body BD, the ultrasonic sensors 31a, 31g are symmetrically arranged on the left and the right, respectively, the ultrasonic sensors 31b, 31f are symmetrically arranged on the left and the right, respectively, and the ultrasonic sensors 31c, 31e are symmetrically arranged on the left and the right, respectively. When the travel direction of the body BD is perpendicular to the forward wall, the distances calculated by the ultrasonic sensors 31 symmetrically arranged on the left and the right are all same.

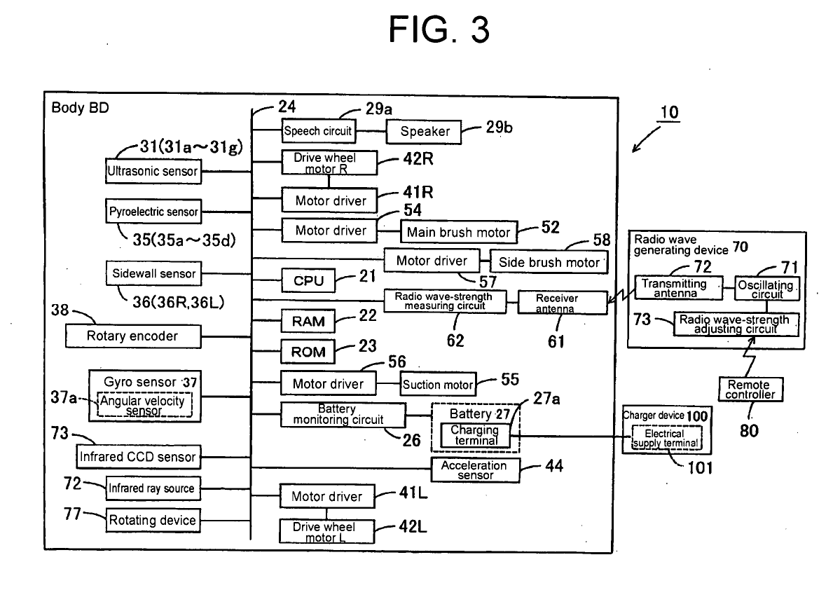

Moreover, pyroelectric sensors 35 (35a, 35b) that act as human body sensors for sensing a human body are provided on the left and right of the front side of the body BD. The pyroelectric sensors 35a, 35b can detect a human present in the vicinity of the body BD, by sensing infrared rays generated from the human body. Incidentally, though not shown in FIG. 1, pyroelectric sensors 35 (35c, 35d) are provided on the left and right of a rear side of the body BD (FIG. 3). Thus, the pyroelectric sensors 35 are constructed so as to have a sensing range of 360° around the body BD.

Moreover, though sidewall sensors that are comprised of photo reflectors as will be discussed hereinafter are not shown in FIG. 1, the sidewall sensors 36 (36R, 36L) are respectively provided on the left and right of the rear side of the body BD (FIG. 3). The photo reflectors detect sidewalls of the room and act as means to facilitate maintaining of a predetermined distance between the body BD and the sidewalls during the traveling of the self-propelled cleaner. Also, the photo reflectors are used to detect a charger device at the time when automatic charging is carried out as will be discussed hereinafter. Incidentally, positions at which the sidewall sensors are arranged will be discussed hereinafter with reference to FIG. 3.

As shown in FIG. 2, the two drive wheels 12R, 12L are respectively provided on the left and right of the bottom of the body BD. Moreover, three supplementary wheels 13 are provided at a forward region of the bottom of the body BD (on the travel direction side). Furthermore, step sensors 14 for detecting unevenness of a room floor surface and steps of the room floor surface are provided at the upper right-hand region, lower right-hand region, upper left-hand region and lower left-hand region of the bottom of the body BD in FIG. 2. A main brush 15 is provided at a region of the bottom of the BD that is below the central portion of the bottom of the body BD in FIG. 2. The main brush 15 is rotationally driven by a main brush motor 52 (not shown in FIG. 2 but shown in FIG. 3) and can sweep dirt and/or dust on the room floor surface. Moreover, an opening formed in a portion of the body BD to which the main brush 15 is attached is a suction inlet. The dirt and/or dust is adapted to be sucked into the suction inlet while being swept by the main brush 15. Furthermore, side brushes 16 are provided at the upper right-hand region and upper left-hand region of the bottom of the body BD in FIG. 2.

Incidentally, the self-propelled cleaner 10 according to the present invention is provided with various sensors in addition to the ultrasonic sensors 31, the pyroelectric sensors 35, the step sensors 14 and the sidewall sensors 36 that are shown in FIG. 1 or 2. The various sensors other than the sensors 31, 35, 14, 36 will be discussed in greater detail hereinafter with reference to FIG. 3.

(2) Internal Structure of the Self-Propelled Cleaner:

FIG. 3 is a schematic block diagram illustrating a structure of the automatic cleaning system comprised of the self-propelled cleaner of FIGS. 1 and 2, and a radio wave generating device. As shown in FIG. 3, CPU 21, ROM 23 and RAM 22 that serve as a control section are coupled to the body BD through a bus 24. The CPU 21 uses the RAM 22 as a work area and carries out various controls according to a control program and various parameter tables which are stored in the ROM 23.

The body BD is provided with a battery 27. The CPU 21 is adapted to be able to monitor a residual quantity of the battery 27 through a battery monitoring circuit 26. Moreover, the battery 27 is provided with a charging terminal 27a that is to be used for charging of the battery 27 by the charger device 100 described above. The charging terminal 27a of the battery 27 is operatively coupled to an electrical supply terminal 101 of the charger device 100, whereby the charging is carried out. The battery monitoring circuit 26 mainly monitors a voltage of the battery 27 and then detects the residual quantity of the battery 27. Moreover, the body BD has a speech circuit 29a that is coupled to the bus 24. A speaker 29b generates voice according to a speech signal that is produced in the speech circuit 29a.

As discussed above, the body BD is provided with the ultrasonic sensors 31 (31a-31g) serving as the forward obstacle sensors, the pyroelectric sensors 35 (35a-35d) acting as the human body sensors, and the step sensors 14 (see FIGS. 1 and 2). Moreover, the body BD is provided with the sidewall sensors 36R, 36L for detecting the sidewalls of the room, as some of the other sensors that are not shown in FIGS. 1 and 2. In the illustrated example, the sidewall sensors 36R, 36L are comprised of photo reflectors that comprise light emitting sections for emitting infrared rays and light receiving sections for receiving the infrared rays reflected by the sidewalls. However, as the sidewall sensors employed in the present invention, there may be employed ultrasonic sensors etc. Moreover the body BD is provided with a gyro sensor 37 as one of the above-mentioned other sensors. The gyro sensor 37 comprises an angular velocity sensor 37a for detecting a change in an angular velocity which is caused by change in the travel direction of the body BD, and can detect an angle of a direction to which the body BD is directed, by carrying out multiplying of a sensor output value detected by the angular velocity sensor 37a.

The self-propelled cleaner 10 according to the present invention is provided with motor drivers 41R, 41L, drive wheel motors 42R, 42L, and an unshown gear unit arranged between the drive wheel motors 42R, 42L and the above-mentioned drive wheels 12R, 12L, as a drive mechanism. When the body BD is turn-traveled, the rotational direction and rotation angle of the drive wheel motors 42R, 42L are particularly controlled by the motor drivers 41R, 41L. The respective motor drivers 41R, 41L output corresponding drive signals according to control signals supplied from the CPU 21. Incidentally, as the gear unit and the drive wheels 12R, 12L, there may be employed various gear units and drive wheels. The driving of the self-propelled cleaner 10 may be realized by causing round-shaped rubber tires to be driven or causing an endless belt to be driven.

Moreover, the body BD is provided with a rotary encoder 38. The rotary encoder 38 is attached to the body BD integrally with the drive wheel motors 42R, 42L and adapted to be able to calculate a travel distance of the body BD from the number of revolutions of the drive wheels 12R, 12L. Incidentally, the rotary encoder 38 may not be attached directly to the drive wheels and a freely rotatable driven wheel may be provided in the vicinity of the drive wheels. In this case, a rotating amount of the driven wheel is fed back, whereby actual rotating amounts of the drive wheels can be detected even if slipping of the drive wheels occurs. Furthermore, an acceleration sensor 44 detects acceleration in three XYZ-axial directions, and then outputs the detection results.

A cleaner mechanism of the self-propelled cleaner 10 according to the present invention comprises the two side brushes 16 provided at the bottom of the body BD (see FIG. 2), the main brush 15 provided at the central portion of the bottom of the body BD (see FIG. 2), and a suction fan (not shown) for sucking dirt and/or dust swept by the main brush 15 and causing the dirt and/or dust to be stored in a dust box. The main brush 15 is adapted to be driven by the main brush motor 52. Also, the side brushes 16 are adapted to be driven by a side brush motor 58. The suction fan is adapted to be driven by a suction motor 55. The main brush motor 52, the side brush motor 58, and the suction motor 55 are adapted to be respectively drive-controlled by motor drivers 54, 57, 56. The cleaning operation which is carried out using these motors is suitably judged and controlled by the CPU 21, according to strength of a radio wave dispatched from the radio wave generating device 70 that will be discussed in greater detail hereinafter.

Moreover, the body BD is provided with the infrared CCD sensor 73 and an infrared ray source 72. An image picking-up signal that is produced in the infrared CCD sensor 73 is transmitted through the bus 24 to the CPU 21 in which the image picking-up signal is subjected to various processes. The infrared CCD sensor 73 comprises an optical system that can pick up an image of an area in front of the body BD, and produces an electric signal according to infrared rays that are incident on a field of view that is realized by the optical system. Concretely, there are provided a plurality of photodiodes that are arranged correspondingly to respective picture elements at an image formation location that is determined by the above-mentioned optical system. The respective photodiodes produce electric signals that correspond to electrical energies of the incident infrared rays. A CCD element temporarily memorizes the electric signals that are produced for every picture elements, and produces image picking-up signals in which electric signals are continued for the respective picture elements. Then, the produced image picking-up signals are suitably outputted to the CPU 21.

Moreover, the body BD is provided with a radio wave receiver antenna 61 and a radio wave-strength measuring circuit 62 for measuring strength of a radio wave received by the receiver antenna 61. The receiver antenna 61 is adapted to receive a radio wave dispatched from the radio wave generating device 70 described hereinafter. The radio wave-strength measuring circuit 62 is adapted to measure the strength of the radio wave received by the receiver antenna 61, and output the measuring results to the CPU 21. A predetermined threshold level for the strength of the radio wave received by the receiver antenna 61 is previously memorized in the ROM 23. Comparison is made between the measuring results supplied to the CPU 21 by the radio wave-strength measuring circuit 62 and the above threshold level memorized in the ROM 23. When the measuring results exceed the threshold level, a noise suppressing process in which noise generated by the body BD in use is reduced is carried out. This noise suppressing process will be discussed in greater detail hereinafter. A hard ware and a soft ware constitute a noise suppressing control processor that carries out the noise suppressing process.

The radio wave generating device 70 that is one of the mechanisms constituting the automatic cleaning system according to the present invention is provided with an oscillating circuit 71 for generating a radio wave, a radio wave transmitting antenna 72 for transmitting the radio wave generated by the oscillating circuit 71, and a radio wave-strength adjusting circuit 73 for adjusting strength of the radio wave generated by the oscillating circuit 71. The radio wave-strength adjusting circuit 73 is adapted to enhance or lower the strength of the radio wave produced by the oscillating circuit 71, according to operation of a remote controller 80 which is performed by a user.

As a distance from the radio wave transmitting antenna 72 becomes larger, the strength of the radio wave transmitted from the radio wave transmitting antenna 72 becomes lower. Therefore, in a case where the strength of the radio wave transmitted from the transmitting antenna 72 is constant, when the strength of the radio wave received by the body BD of the self-propelled cleaner 10 becomes the above-mentioned threshold level, a distance between the body BD and the radio wave generating device 70 always becomes constant.

However, if the strength of the radio waved transmitted from the transmitting antenna 72 is changed by operating the remote controller 80, the distance between the body BD and the radio wave generating device 70 at the time when the strength of the radio wave received by the body BD becomes the predetermined threshold level is also changed.

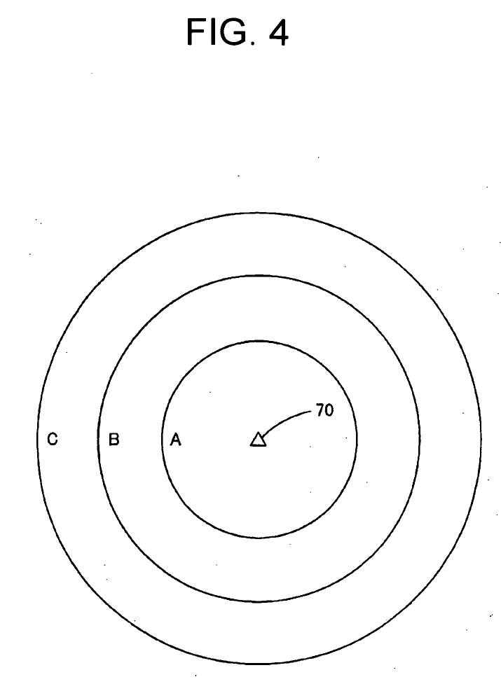

FIG. 4 is a schematic view illustrating areas in which the body BD is to be subjected to the noise suppressing process. The automatic cleaning system according to the embodiment of the present invention will be discussed hereinafter as the automatic cleaning system in which the strength of the radio wave transmitted from the transmitting antenna 72 is changed to three levels (high, middle and low levels) by operating the remote controller 80. In a case where the strength of the radio wave transmitted from the transmitting antenna 72 is set to a low level, when the body BD is moved to an area A shown in FIG. 4, the radio wave-strength which is measured by the radio wave measuring circuit 62 exceeds the predetermined threshold level, so that the noise suppressing process is carried out.

Also, in a case where the strength of the radio wave transmitted from the transmitting antenna 72 is set to a middle level, when the body BD is moved to an area B shown in FIG. 4, the noise suppressing process is carried out. Moreover, in a case where the strength of the radio wave transmitted from the transmitting antenna 72 is set to a high level, when the body BD is moved to an area C shown in FIG. 4, the noise suppressing process is carried out.

(3) Operation of the Self-Propelled Cleaner:

Next, the operation of the self-propelled cleaner 10 according to the present invention will be discussed hereinafter.

The self-propelled cleaner 10 according to the present invention is designed so as to be able to carry out cleaning while being self-propelled according to the control program that is previously memorized in the ROM 23 etc. When the walls of the room or the unevenness of the floor surface are detected by the sensors during the self-propelled cleaner carries out the cleaning while being self-propelled, the travel of the self-propelled cleaner is controlled according to the above-mentioned control program.

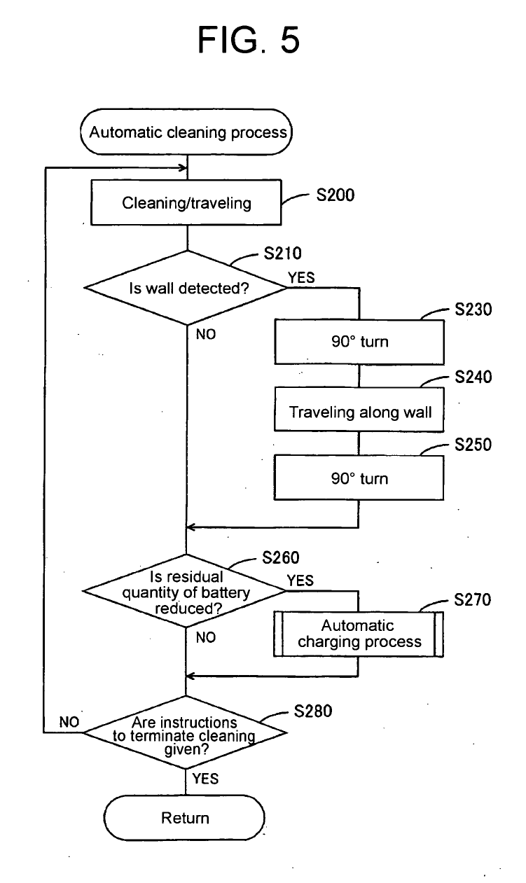

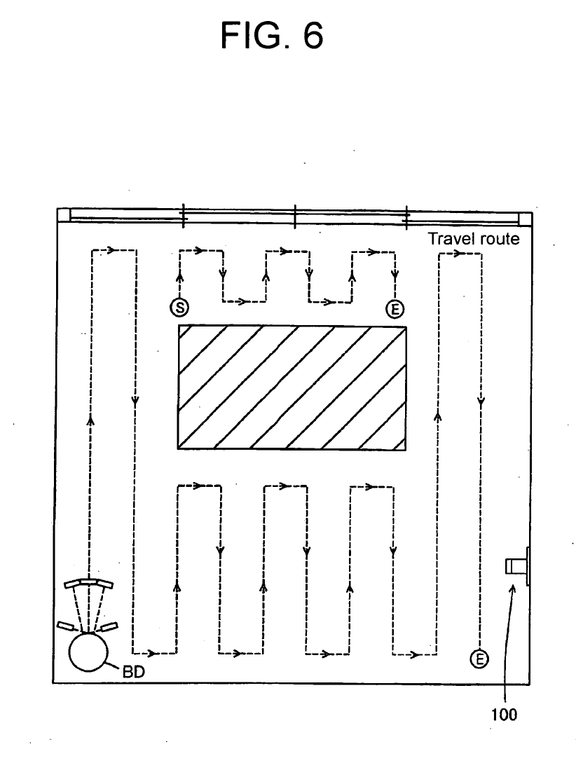

An automatic cleaning process that is carried out by the self-propelled cleaner 10 according to the embodiment of the present invention will be discussed hereinafter on the basis of a flow chart shown in FIG. 5. FIG. 5 illustrates a flow chart exhibiting the automatic cleaning process. FIG. 6 is a schematic view illustrating one example of a travel route along which the self-propelled cleaner 10 is traveled during the automatic cleaning process is carried out. First of all, the self-propelled cleaner 10 carries out the cleaning while being traveled at a step S200. More particularly, at the step S200, the drive wheel motors 42R, 42L are driven to thereby cause the self-propelled cleaner 10 to be straightly advanced. During the straight advancing of the self-propelled cleaner 10, detection results obtained by the various sensors provided at the self-propelled cleaner 10 are inputted. According to the detection results, the driving of the self-propelled cleaner 10 is controlled. Moreover, the main brush motor 52, the side brush motor 58, and the suction motor 55 are driven, whereby the cleaning is carried out. Furthermore, when a change in an angle of a direction to which the body BD is directed is detected by the gyro sensor 37, the driving of the drive wheel motor 42R or 42L is controlled, whereby the travel direction of the body BD is corrected and the straight travel of the body BD is maintained.

When the process at the step S200 is completed, whether or not the forward wall of the room has been detected is judged at a step S210. That is, whether or not the wall present in the travel direction of the body BD has been detected by the ultrasonic sensors is judged. When it is judged at the step S210 that the forward wall has been detected, the body BD is turned 90° at a step S230. When this process is performed, the body BD is traveled in parallel with the wall. For example, the self-propelled cleaner begins cleaning while being traveled from a cleaning start location in FIG. 6, and is controlled such that the body BD is turned 90° to the right, when an upper wall in FIG. 6 is detected. When the process at the step S230 is completed, traveling of the body BD along the wall is carried out at a step S240. In this process, the main brush motor 52 and the suction motor 55 are driven, whereby the self-propelled cleaner carries out the cleaning while being traveled. At this time, the self-propelled cleaner is controlled by the gyro sensor 37 in such a manner that the travel direction of the body BD becomes parallel to the wall. When the traveling of the body BD along the wall is completed at the step S240, the body BD is again turned 90 at a step S250. After the body BD is traveled along the upper wall in FIG. 6 by a predetermined distance, the body BD is again turned 90 to the right, whereby the body BD becomes perpendicular to the wall. Then, the body BD is traveled in such a direction as to be away from the wall.

In a case where the process at the step S250 is carried out or it is judged at the step S210 that the wall has not been detected, whether or not the residual quantity of the battery 27 has been reduced is judged at a step S260. In this process, whether or not the residual quantity of the battery 27 that is detected by the battery monitoring circuit 26 is below a predetermined reference level is judged. When it is judged at the step S260 that the residual quantity of the battery 27 has been below the predetermined reference level, an automatic charging process is carried out at a step S270. This process is a process in which the body BD is automatically traveled to the charger device 100 located on a predetermined wall of a room subjected to cleaning, the charging terminal 27a of the body BD is operatively connected to the electrical supply terminal 101 of the charger device 100, and charging is then carried out.

In a case where the process at the step S270 is carried out or it is judged at the step S260 that the residual quantity of the battery has not been reduced, whether or not instructions to terminate the cleaning are given is judged at a step S280. When it is judged that the instructions have not been given, the process is returned to the step S200. On the other hand, when it is judged that the instructions have been given, the automatic cleaning process is terminated.

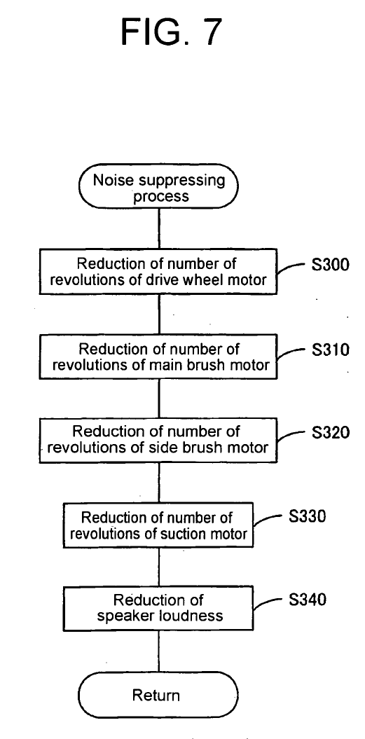

Next, the noise suppressing process which is carried out by the self-propelled cleaner 10 according to the embodiment of the present invention will be discussed hereinafter on the basis of a flow chart shown in FIG. 7. FIG. 7 illustrates a schematic flow chart exhibiting the noise suppressing process. In the automatic cleaning process which is discussed above with reference to FIG. 5, when the strength of the radio wave provided from the radio wave generating device 70 which is measured by the radio wave-strength measuring circuit 62 exceeds the predetermined threshold level, the noise suppressing process is accessed and performed. When the noise suppressing process is commenced, first of all, the number of revolutions of the drive wheel motors is reduced at a step S300. In this process, the CPU 21 sends control signals to the motor drivers 41R, 41L, whereby the number of the revolutions of the drive wheel motors 42R, 42L is reduced. By this process, a travel speed of the body BD (average travel-speed) is reduced.

Next, the number of revolutions of the main brush motor is reduced at a step S310. In this process, a control signal is sent to the motor driver 52, whereby the number of the revolutions of the main brush motor 52 is reduced. By this process, a rotational speed of the main brush motor 52 is reduced.

Next, the number of revolutions of the side brush motor is reduced at a step S320. In this process, a control signal is sent to the motor driver 57, whereby the number of revolutions of the side brush motor 58 is reduced. By this process, a rotational speed of the side brush motor is reduced.

Next, the number of revolutions of the suction motor is reduced at a step S330. In this process, a control signal is sent to the motor driver 56, whereby the number of revolutions of the suction motor 55 is reduced. By this process, a rotational speed of the suction motor is reduced and suction power is therefore reduced.

Next, loudness of the speaker is reduced at a step S340. In this process, the volume of a voice generated from the speaker 29b is reduced. When the process at the step S340 is completed, the noise suppressing process is terminated.

(4) Various Variants:

In the above-mentioned embodiment, the noise suppressing process is carried out by causing the number of the revolutions of the drive wheel motors 42R, 42L, main brush motor 52, side brush motor 58 and suction motor 55 to be reduced and causing the loudness of the speaker to be reduced. However, it is unnecessary to cause all of noises produced at the time of the operation of these motors to be reduced and any of the noises may be reduced. Moreover, in a case where the self-propelled cleaner 10 is provided with another mechanism that generates noise at the time of its operation, in addition to the mechanisms that are provided at the self-propelled cleaner according to the above-mentioned embodiment, noise generated by the another mechanism may be reduced.

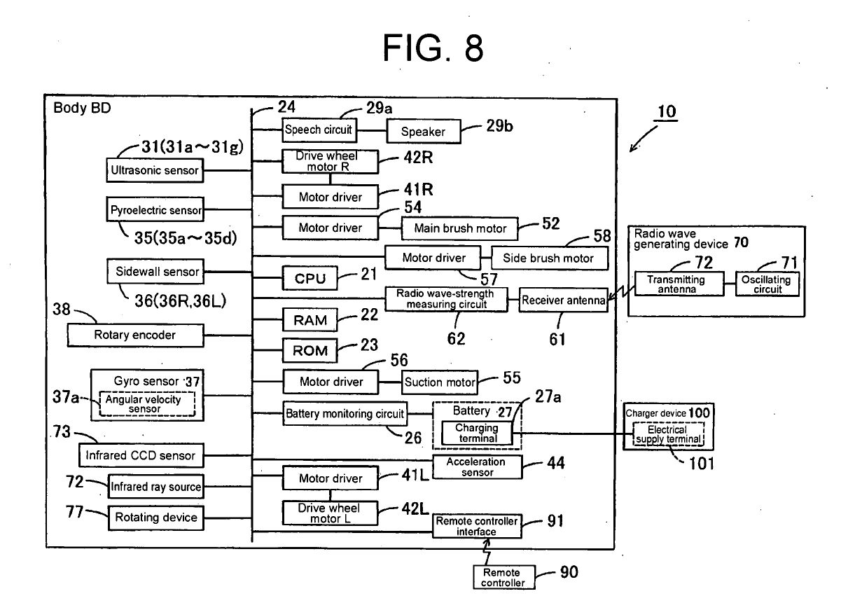

Moreover, the case where the strength of the radio wave generated from the radio wave generating device 70 is changed according to the operation of the remote controller is discussed above in connection with the embodiment. However, the present invention may be applied to an automatic cleaning system that is designed so that the strength of the radio wave generated from the radio wave generating device 70 is kept constant, multiple threshold levels for a radio wave-strength are set on the side of the self-propelled cleaner 10, and a threshold level to be set is changed according to the operation of a remote controller. Referring now to FIG. 8, there is illustrated an automatic cleaning system according to another embodiment of the present invention. In this embodiment, the radio wave-strength adjusting circuit 73 employed in the above-mentioned embodiment is omitted in the radio wave generating device 70 and the body BD of the self-propelled cleaner 10 is provided with a remote controller 1/F 91 for receiving a signal sent from a remote controller 90. Moreover, multiple threshold levels (for example, three threshold levels) for strength of the radio wave received by the receiver antenna 61 are memorized in the ROM 23. On the basis of a signal provided by operating of the remote controller 60 by the user, any one of the threshold levels is set. Then, comparison is made between the set threshold level and the measuring results obtained by the radio wave-strength measuring circuit 62. By doing so, like the case where the radio wave generating device 70 is designed so as to change the strength of the generated radio wave, it is possible to change a distance between the body BD and the radio wave generating device 70 at the time when the radio wave-strength measured by the radio wave-strength measuring circuit 62 exceeds the predetermined threshold level.

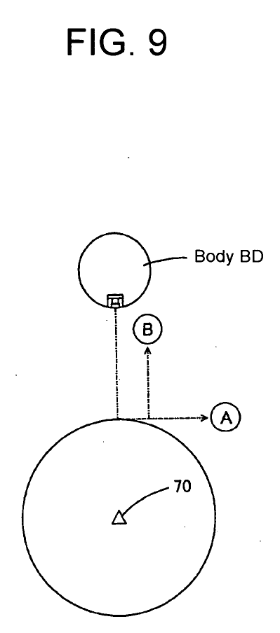

Moreover, in the present invention, the body may be controlled so as not to enter an area in which the strength of the radio wave received by the self-propelled cleaner exceeds the predetermined threshold level. For example, as shown in FIG. 9, when the strength of the radio wave that is measured by the radio wave-strength measuring circuit 62 exceeds the predetermined threshold level, the body BD may be turned 90° as indicated in FIG. 9 by A or may be turned 180° as indicated in FIG. 9 by B, whereby the body is prevented from entering the area in which the radio wave-strength exceeds the predetermined threshold level.

(5) Summary:

As described above, the automatic cleaning system according to the embodiments of the present invention is provided with the receiver antenna 61 for receiving the radio wave sent from the radio wave generating device 70, and the radio wave-strength measuring circuit 62 for measuring the strength of the radio wave received by the receiver antenna 61. When the radio wave-strength measured by the radio wave-strength measuring circuit 62 exceeds the predetermined threshold level, the number of the revolutions of the drive wheel motors 42R, 42L, main brush motor 52, side brush motor 58 and suction motor 55 provided at the body BD of the self-propelled cleaner 10 is reduced, and the loudness of the speaker 29b is reduced. Therefore, it is possible to reduce noise that is produced by the body BD of the self-propelled cleaner approaching a predetermined area spaced from the radio wave generating device 70.

The terms and expressions which have been employed herein are used as terms of description, not of limitation. There is no intention in the use of such terms and expressions of excluding any equivalents of the features shown and described or portions thereof. However, it is recognized that various modifications are possible within the scope of the invention claimed.

We claim:

1. An automatic cleaning system comprising:
a self-propelled cleaner; and
a radio wave generating device for generating a radio wave of a predetermined wavelength;
said radio wave generating device being adapted to be able to change strength of the radio wave to be generated, according to a predetermined operation;
said self-propelled cleaner comprising:
a body;
a cleaner mechanism provided at said body;
said cleaner mechanism including a main brush, a main brush motor for causing said main brush to be rotationally driven, side brushes, and a side brush motor for causing said side brushes to be rotationally driven;
a drive mechanism for realizing steering and driving of said body;
said driven mechanism including drive motors for causing said body to be travel-driven;
a radio wave receiver circuit for receiving the radio wave generated from said radio wave generating device;
a radio wave-strength measuring circuit for measuring strength of the radio wave received by said radio wave receiver circuit; and
a noise suppressing control processor for reducing noise generated from said body in use of said self-propelled cleaner, by causing the number of revolutions of said drive motors, main brush motor and side brush motor to be reduced or for causing said body to be moved to an area in which radio wave-strength measured by said radio wave-strength measuring circuit does not exceeds a predetermined threshold level, when the radio wave-strength measured by said radio wave-strength measuring circuit exceeds the predetermined threshold level.

2. An automatic cleaning system comprising:
a self-propelled cleaner; and
a radio wave generating device for generating a radio wave of a predetermined wavelength;
said self-propelled cleaner comprising:
a body;
a cleaner mechanism provided at said body;
a drive mechanism for realizing steering and driving of said body;
a radio wave receiver circuit for receiving the radio wave generated from said radio wave generating device;
a radio wave-strength measuring circuit for measuring strength of the radio wave received by said radio wave receiver circuit; and
a noise suppressing control processor for reducing noise generated from said body in use of said self-propelled cleaner, when the radio wave-strength measured by said radio wave-strength measuring circuit exceeds a predetermined threshold level.

3. An automatic cleaning system according to claim 2, wherein said drive mechanism includes drive motors for causing said body to be travel-driven and said noise suppressing control processor is designed so as to cause the number of revolutions of said drive motors to be reduced.

4. An automatic cleaning system according to claim 2, wherein said cleaner mechanism includes a main brush and a main brush motor for causing said main brush to be rotationally driven, and said noise suppressing control processor is designed so as to cause the number of revolutions of said main brush motor to be reduced.

5. An automatic cleaning system according to claim 2, wherein said cleaner mechanism includes side brushes and a side brush motor for causing said side brushes to be rotationally driven, and said noise suppressing control processor is designed so as to cause the number of revolutions of said side brush motor to be reduced.

6. An automatic cleaning system according to claim 2, wherein said noise suppressing control processor is designed so as to control said body in such a manner to prevent said body from entering an area in which the radio wave-strength measured by said radio wave-strength measuring circuit exceeds the predetermined threshold level.

7. An automatic cleaning system according to claim 2, wherein said radio wave generating device is designed so as to be able to change strength of the radio wave to be generated, according to a predetermined operation.

8. An automatic cleaning system according to claim 2, wherein said self-propelled cleaner is designed so as to be able to change the predetermined threshold level according to a predetermined operation.

9. An automatic cleaning system according to claim 2, wherein said automatic cleaning system further includes a CPU, a ROM and a RAM that act as a control section and are connected through a bus to said body of said self-propelled cleaner, said CPU being designed so as to use said RAM as a work area and carry out various controls, according to a control program and various parameter tables that are memorized in said ROM.

10. An automatic cleaning system according to claim 9, wherein said drive mechanism comprises a pair of motor drivers, left and right drive wheel motors, left and right drive wheels, and a gear unit arranged between said drive wheel motors and said drive wheels, wherein rotational directions and rotation angles of said drive wheel motors are particularly controlled by said motor drivers at the time when the body is turned, and wherein said motor drivers are adapted to output drive signals that correspond to predetermined control instructions given from said CPU, according to the predetermined control instructions.

11. An automatic cleaning system according to claim 9, wherein said body is provided with a receiver antenna for receiving the radio wave generated from said radio wave generating device and said radio wave-strength measuring circuit is provided at said body, said radio wave-strength measuring circuit being adapted to measure strength of the radio wave received by said receiver antenna and provide measuring results to said CPU.

12. An automatic cleaning system according to claim 11, wherein said predetermined threshold level is memorized in said ROM for the strength of the radio wave received by said receiver antenna, and wherein said noise suppressing control processor is designed so as to make a comparison between the measuring results supplied to said CPU by said radio wave-strength measuring circuit, and said predetermined threshold level memorized in said ROM, and carry out a noise suppressing process in which noise produced from said body is reduced, when said measuring results exceed said threshold level.

13. An automatic cleaning system according to claim 9, wherein said radio wave generating device comprises an oscillating circuit for generating the radio wave, a radio wave transmitting antenna for transmitting the radio wave generated by said oscillating circuit, and a radio wave-strength adjusting circuit for adjusting strength of the radio wave generated from said oscillating circuit, and wherein the strength of the radio wave transmitted from said radio wave transmitting antenna is adapted to become lower as a distance between said radio wave transmitting antenna and said body becomes greater.

14. An automatic cleaning system according to claim 13, wherein said radio wave-strength adjusting circuit is adapted to enhance or lower the strength of the radio wave produced by said oscillating circuit, according to operation of a remote controller which is performed by a user.

15. An automatic cleaning system according to claim 14, wherein the strength of the radio wave transmitted from said radio wave transmitting antenna can be changed to three levels, namely, a low level, a middle level and a high level, according to the operation of said remote controller.

16. An automatic cleaning system according to claim 9, wherein during cleaning by said self-propelled cleaner, a noise suppressing process is accessed and carried out, when the strength of the radio wave from said radio wave generating device that is measured by said radio wave-strength measuring circuit exceeds the predetermined threshold level.

17. An automatic cleaning system according to claim 9, wherein said automatic cleaning system is designed so that the strength of the radio wave generated from said radio wave generating device is kept constant, multiple threshold levels for a radio wave-strength are set on the side of said self-propelled cleaner, and a threshold level to be set is changed according to operation of a remote controller.

18. An automatic cleaning system according to claim 9, wherein said body of said self-propelled cleaner is provided with a remote controller I/F for receiving a signal transmitted from a second remote controller which is operated by a user, and a receiver antenna, wherein said ROM memorizes multiple threshold levels for strength of a radio wave received by said receiver antenna, and wherein any one of said multiple threshold levels is set on the basis of the signal provided by operating of said second remote controller by the user and comparison is made between the set threshold level and the measuring results obtained by said radio wave-strength measuring circuit.

19. An automatic cleaning system according to claim 9, wherein said self-propeller cleaner is provided with a plurality of motors and wherein only noise produced by any of the plurality of motors are adapted to be reduced.

20. A self-propelled cleaner comprising:
a body;
a cleaner mechanism provided at said body;
a drive mechanism for realizing steering and driving of said body;
a radio wave receiver circuit for receiving a radio wave generated from a radio wave generating device for generating a radio wave of a predetermined wavelength;
a radio wave-strength measuring circuit for measuring strength of the radio wave received by said radio wave receiver circuit; and
a noise suppressing control processor for reducing noise generated from said body in use of said self-propelled cleaner, when the radio wave-strength measured by said radio wave-strength measuring circuit exceeds a predetermined threshold level.
